(19) United States
(12) Patent Application Publication
(10) Pub. No.: US 2010/0023662 A1
(43) Pub. Date: Jan. 28, 2010

(54) BUS MASTERING METHOD

(76) Inventor: Lian-Chun Lee, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/248,050

(22) Filed: Oct. 9, 2008

(30) Foreign Application Priority Data
Jul. 24, 2008 (TW) 097128115

(51) Int. Cl. G06F 13/36

(52) U.S. Cl. 710/107

(57) ABSTRACT

A mastering method of a bus includes the following steps: receiving a command; determining if the command is a bus master command to generate a determined result; outputting at least one break event to switch a processor from a non-snoop state into a snoop state according to the determined result; and outputting at least one bus master request to access the bus; wherein the break event is ahead of the bus master request that corresponds to the break event.

### BACKGROUND OF THE INVENTION

1. Field of the Invention

The present invention relates to a bus mastering method, and more particularly, to a bus mastering method that awakens a processor controlling the bus under a low power consumption mode before a bus master command is received by the processor.

2. Description of the Prior Art

In the field of portable electronic devices, the standby time of a portable electronic product is one of the most critical problems of the portable electronic product, and is also a key factor for a consumer when determining whether to purchase the portable electronic product. For a notebook computer, the efficiency of the processor is always proportional to its power consumption. In other words, the notebook computer does not operate at a high efficiency while maintaining a low power consumption. Normally, the power state of the processor is categorized into the following states: C0, C1, C2, C3, C4, and C3 pop-up/pop-down, wherein when the processor is under the state C0, the processor has the highest processing efficiency but the power consumption is also the highest. Under the state C1, the processor stops executing commands but is still able to maintain data in the cache of the operating system. Under the state C2, the processor is in a stop grant state, in which the processor does not allow the bus to be accessed, and the processor further snoops the bus and maintains the coherency of data in the cache of the processor. Furthermore, the time required by the processor to switch into the state C0 from the state C2 is longer than the time to switch into the state CO from the state C1. Under the state C3, the processor is in a stop-clock state, in which the processor is controlled by an arbiter. Furthermore, the memory that corresponds to the processor in the notebook computer is not allowed to be accessed, and the coherency of the data in the cache of the processor is maintained by the operating system of the notebook computer. In addition, the time required by the processor to switch into the state C0 from the state C3 is longer than the time to switch into the state C0 from the states C2 and C1. Under the state C4, the processor is in the stop-clock state and the processor is operated under a lower supply voltage, which is similar to the state C3. However, the time required by the processor to switch into the state C0 from the state C4 is longer than the time to switch into the state C0 from the state C3. The state C3 pop-up/pop-down is similar to the states C3 and C4, but the processor is not controlled by the arbiter under the state C3 pop-up/pop-down. Under the state C3 pop-up/pop-down, a bus master command is continuously transmitted into the processor in order to switch the processor into the state C2 from the state C3 pop-up/pop-down, in which the processor keeps switching back to the state C3 pop-up/pop-down from the state C2. Therefore, according to the above-mentioned states, if a computer peripheral device needs to access the bus mastered by the processor, in which the processor is in a sleeping state deeper than the state C2 (i.e., the states C3, C4, or C3 pop-up/pop-down), the processor will allow the computer peripheral device to access the bus after a specific latency time. However, the specific latency time of the processor may cause an overrun or under-run phenomenon of a command transmitted from the computer peripheral device during the specific latency time. Therefore, to increase the operating speed of the processor for processing the command transmitted from the computer peripheral device while keeping the processor operating under a low power consumption state is becoming the most urgent problem in the field of computers.

### SUMMARY OF THE INVENTION

Therefore, one of the objectives of the present invention provides a bus mastering method that awakens a processor controlling the bus under a low power consumption mode before a bus master command is received by the processor.

According to an embodiment of the present invention, a mastering method of a bus is provided. The mastering method comprises the following steps: receiving a command; determining if the command is a bus master command to generate a determined result; outputting at least one break event to switch a processor from a non-snoop state into a snoop state according to the determined result; and outputting at least one bus master request to access the bus; wherein the break event is ahead of the bus master request corresponding to the break event.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram of a bus mastering method according to an embodiment of the present invention.

FIG. 2 is a flowchart of the bus mastering method of the present invention.

FIG. 3 is a timing diagram of a bus master command transmitted from a computer peripheral device to a processor.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

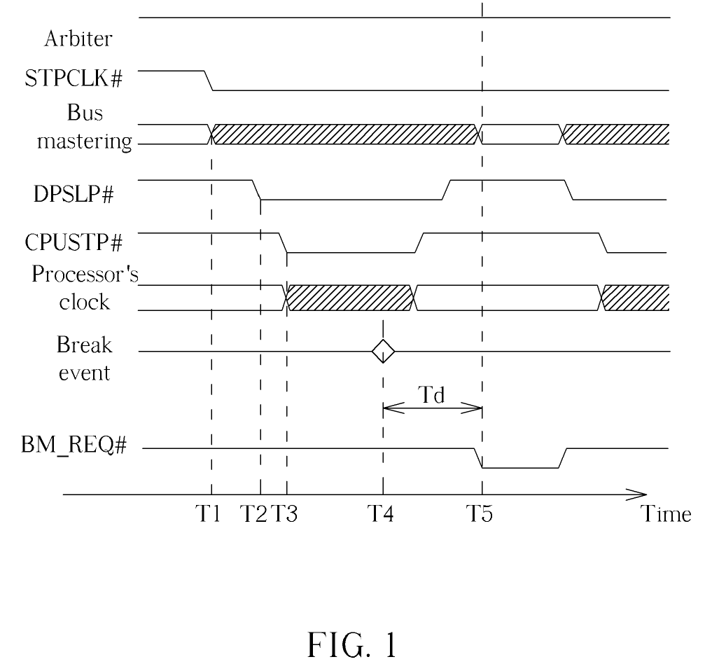

Please refer to FIG. 1. FIG. 1 is a timing diagram illustrating a bus mastering method according to an embodiment of the present invention. The bus is controlled by a processor, and the processor is under a non-snoop state. Please note that, in order to describe the spirit of the present invention more clearly, the bus mastering method is interpreted through an accessing operation from a computer peripheral device to the bus controlled by the processor of the computer, but this is not a limitation of the present invention. In other words, any configuration that includes a peripheral device for accessing a bus controlled by a processor belongs to the scope of the present invention, e.g., any memory bus configuration that interfaces the processor (such as a central processing unit, CPU) and a bus master device. For example, the accessing operation from a cell phone peripheral device to a bus controlled by the processor of the cell phone also belongs to the scope of the present invention. In the computer system, a non-snoop state represents the processor of the computer under a low power consumption state, such as a sleep mode, while an operating clock of the processor is stopped, and the processor does not snoop the bus. Please note that those skilled in this art will readily understand that the low power consumption state can be one of the following states: C3, C4, C3 pop-up/pop-down. Therefore, the processor is not restricted to a specific low power consumption state when the bus mastering method of the present invention is being performed. Furthermore, the timing diagram of FIG. 1 shows that an arbiter of the bus is not disabled. However, this is also not a limitation of the present invention. Those skilled in this art can easily implement a bus mastering method with the arbiter that has been disabled under the lower power consumption state through some appropriate modifications upon the disclosed embodiments after reading the disclosure of the present invention, and this also belongs to the scope of the present invention.

In FIG. 1, when the arbiter is enabled, a control signal STPCLK# activates the processor to switch into a state C2 at time T1, i.e., switch into a stop grant state. Meanwhile, the processor does not authorize the peripheral device to access the bus (i.e., a bus mastering enters the oblique line region), and the processor snoops the bus and maintains the coherency of the cache of the processor. Then, when a control signal DPSLP# and a control signal CPUSTP# are enabled at time T2 and time T3 respectively, the processor enters a state C3, i.e., a stop-clock state. Under the state C3, the memory of the computer is not allowed to be accessed, meanwhile the cache of the processor is also not allowed to be snooped, and the coherency of the computer is maintained by an operating system of the computer. Please refer to FIG. 1 again. The clock of the processor is stopped at time T3. According to the bus mastering method of the present invention, before the computer peripheral device outputs an accessing request signal BM_REQ# to access the bus at time T5, a break event is transmitted to the processor to switch the processor into the snoop state from the non-snoop state at time T4, in which the timing of the time T4 is determined by a latency time Td of the processor to switch into the snoop state from the non-snoop state. In other words, the time T4 is equal to T5−Td. Accordingly, the processor can be awakened (i.e., to activate the switching from the state C3 into state C2 at time T4) ahead of the accessing request signal BM_REQ#, then the accessing request signal BM_REQ# can be processed at the time T5 and the bus can also be accessed at the time T5. Please note that the bus mastering method awakens the processor to switch into the state C2 from the state C3, however, this is not a limitation of the present invention. In other words, the processor can be switched into the state C2 from the state C4 after performing some appropriate modifications upon the bus mastering method, and this also belongs to the scope of the present invention. Furthermore, the break event is not a limitation of the present invention. Other signals such as an unmasked interrupt, a bus mastering request, an initial signal (INIT#), a processor pending break event indication, etc, can be utilized as the break event of the bus mastering method.

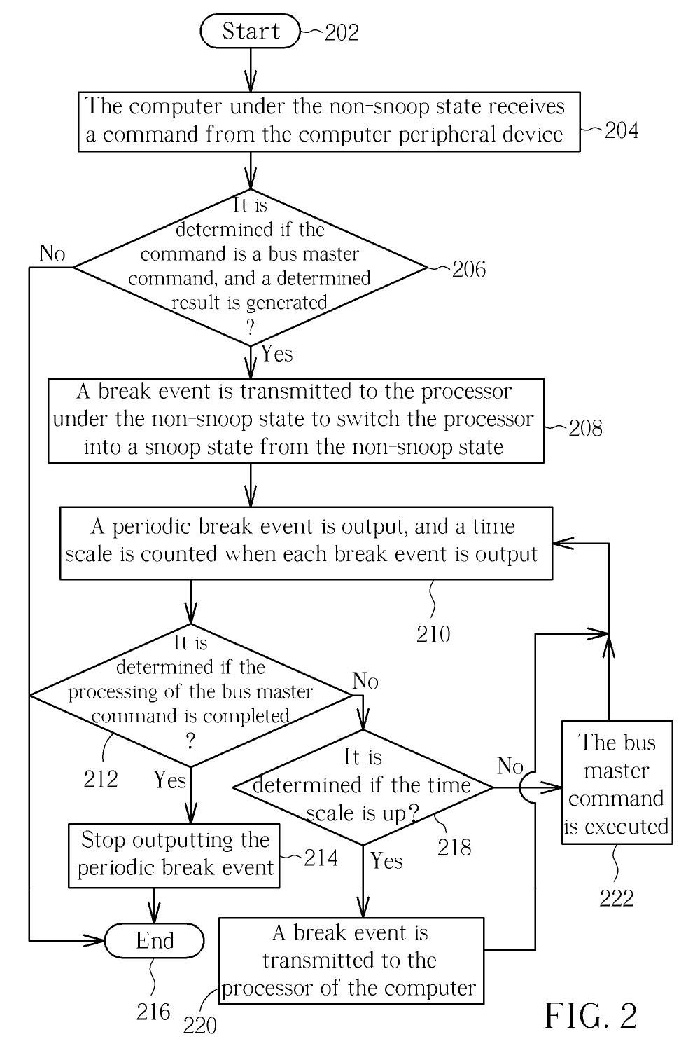

Please refer to FIG. 2. FIG. 2 is a flowchart illustrating the bus mastering method 200 according to the embodiment of the present invention. Similarly, in order to describe the spirit of the present invention more clearly, the bus mastering method 200 is interpreted through an accessing operation from a computer peripheral device to the bus controlled by the processor of the computer. This is not a limitation of the present invention. In other words, any configuration that includes a peripheral device accessing a bus controlled by a processor also belongs to the scope of the present invention, e.g., any memory bus configuration that interfaces the processor (such as a central processing unit, CPU) and a bus master device. For example, the accessing operation from a cell phone peripheral device to a bus that is controlled by the processor of the cell phone also belongs to the scope of the present invention. Provided that substantially the same result is achieved, the steps of the flowchart shown in FIG. 2 need not be in the exact order shown and need not be contiguous, that is, other steps can be intermediate.

The bus mastering method 200 comprises:

Step 202: start;

Step 204: the computer under the non-snoop state receives a command from the computer peripheral device;

Step 206: It is determined if the command is a bus master command, and a determined result is generated; if the determined result indicates the command is the bus master command, go to step 208, if the determined result indicates the command is not the bus master command, go to step 216;

Step 208: a break event is transmitted to the processor under the non-snoop state to switch the processor into a snoop state from the non-snoop state;

Step 210: a periodic break event is output, and a time scale Tint is counted when each break event is output;

Step 212: it is determined if the processing of the bus master command is completed; if the bus master command is completed, go to step 214, if the bus master command is still executing, go to step 216;

Step 214: stop outputting the periodic break event;

Step 216: end;

Step 218: it is determined if the time scale Tint is up, if there is no bus master command received before the time scale Tint is up, go to step 220, if a bus master command is received before the time scale Tint is up, go to step 222;

Step 220: a break event is transmitted to the processor of the computer, go to step 210:

Step 222: the bus master command is executed, go to step 210.

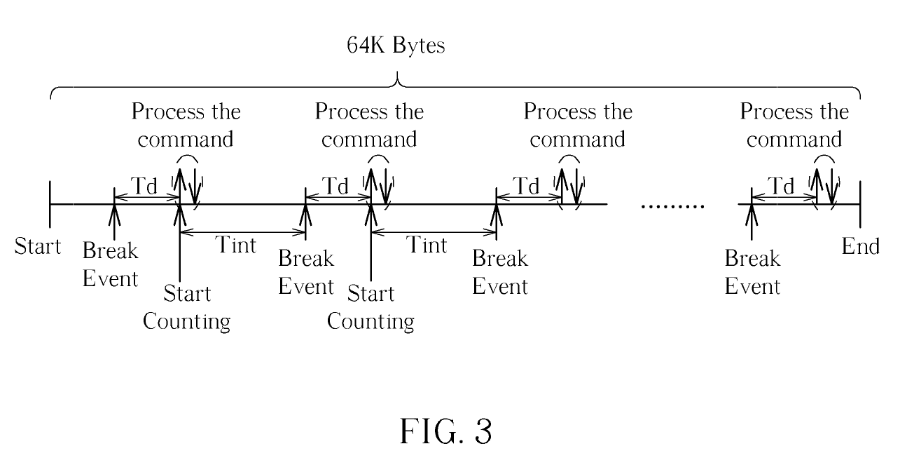

When the processor in the computer does not operate for a period of time, the processor will enter the non-snoop state in order to save power. In step 204, when the computer under the non-snoop state receives a command from the computer peripheral device, the computer first determines if the command is the bus master command, and generates the determined result. If the determined result indicates the command is the bus master command, the computer transmits the break event to the processor in order to switch the processor into the snoop state from the non-snoop state (step 208). Otherwise, the bus mastering method 200 ends the process at step 216. Please note that those skilled in this art will readily understand that the non-snoop state of the processor can be one of the following states: C3, C4, and C3 pop-up/pop-down; and the snoop state of the processor can be one of the following states: C0, C1, and C2. Therefore, the processor is not restricted to a specific non-snoop state and a specific snoop state. Then, the computer outputs the periodic break event according to the size of the bus master command and the latency time Td of the processor, and counts the time scale Tint when each break event is outputted (step 210), as shown in FIG. 3. FIG. 3 is a timing diagram of the bus master command transmitted from the computer peripheral device to the processor. In order to describe the spirit of the present invention more clearly, the size of the bus master command is 64K bytes and the size of a buffer of the computer peripheral device is 128 bytes in this embodiment, but this is not a limitation of the present invention. Accordingly, the bus master command should be transmitted 500 times, in which only 128 bytes of the bus master command are transmitted in each transmission. When each 128 bytes bus master command is transmitted to the computer, the computer determines if the processing of the bus master command is completed (step 212). If the bus master command is still executing, the computer determines if the time scale Tint is up (step 218), wherein the setting of the time scale Tint is for avoiding the phenomenon of buffer overrun or under-run, and thus the time scale Tint is appropriately set according to the latency time Td of the processor. In other words, counting of the time scale Tint can guarantee that the waiting time of each 128 bytes bus master command in the buffer does not exceed the latency time Td of the processor. Then, a break event is transmitted to the processor of the computer if the time scale Tint is up. In FIG. 3, if the 128 bytes bus master command occurs immediately after the latency time Td of the break event, the processor processes the 128 bytes bus master command immediately, and then transmits a feedback signal to the computer peripheral device. Then, the processor returns to the non-snoop state, and starts counting the time scale Tint (step 210). When the time scale Tint is up, the break event again awakens the processor beforehand in order to wait for the next 128 bytes bus master command. In step 218, if the bus master command is received before the time scale Tint is up, it is reset and the method starts counting the time scale Tint again (step 210). Furthermore, in step 212, if the computer determines the bus master command is completed, the bus mastering method 200 ends. Furthermore, the break event is not a limitation of the present invention; other signals like an unmasked interrupt, a bus mastering request, an initial signal (INIT#), a processor pending break event indication, etc, can be utilized as the break event of the bus mastering method 200.

Accordingly, through appropriate setting of the time scale Tint of the bus mastering method 200, the 64K bytes bus master command can be processed at a high speed without buffer overrun or under-run phenomenon, and, at the same time, the power consumption of the processor can be reduced.

Those skilled in the art will readily observe that numerous modifications and alterations of the device and method may be made while retaining the teachings of the invention.

What is claimed is:

1. A mastering method of a bus, comprising:
receiving a command;
determining if the command is a bus master command to generate a determined result;
outputting at least one break event to switch a processor from a non-snoop state into a snoop state according to the determined result; and
outputting at least one bus master request to access the bus;
wherein the break event is ahead of the bus master request that corresponds to the break event.

2. The mastering method of claim 1, wherein the step of outputting the break event according to the determined result comprises:
determining the timing to output the break event according to a latency time of switching from the non-snoop state into the snoop state of the processor.

3. The mastering method of claim 1, wherein the step of outputting the break event according to the determined result comprises:
when the determined result indicates that the command is the bus master command:
(a) outputting the break event;
(b) starting counting a time scale;
(c) when the counting of the time scale is finished and the processor does not receive the bus master request within the time scale, performing the step
(a) to re-output the break event; and
(d) when the processor receives the bus master request within the counting of the time scale, performing the step (b) to re-count the time scale.

4. The mastering method of claim 3, wherein the time scale is determined according to the latency time of switching from the non-snoop state into the snoop state of the processor.

5. The mastering method of claim 4, wherein the time scale is determined according to a size of the command.

6. The mastering method of claim 1, wherein the break event is an unmasked interrupt, a bus mastering request, an initial signal (INIT#), or a processor pending break event indication.
